(19) United States
(12) Patent Application Publication
(10) Pub. No.: US 2025/0390665 A1
(43) Pub. Date: Dec. 25, 2025

(54) INFORMATION PROCESSING APPARATUS, INFORMATION PROCESSING METHOD, AND INFORMATION PROCESSING PROGRAM

(71) Applicant: LY Corporation, Tokyo (JP)

(72) Inventor: Taichi FURUKAWA, Tokyo (JP)

(21) Appl. No.: 19/196,440

(22) Filed: May 1, 2025

(30) Foreign Application Priority Data
Jun. 20, 2024 (JP) 2024-099303

(51) Int. Cl. G06F 40/166; G06F 40/40

(52) U.S. Cl. CPC G06F 40/166; G06F 40/40

(57) ABSTRACT

The information processing apparatus according to the present application includes the first execution unit that executes a predetermined number of sentence generation processes, among a plurality of sentence generation processes continuously executed by using a first generative AI, by using a second generative AI having sentence generation accuracy higher than that of the first generative AI, the generation unit that generates a prompt including an execution result of the second generative AI by the first execution unit, the prompt being for causing the first generative AI to execute remaining sentence generation processes other than the predetermined number of sentence generation processes executed by using the second generative AI, and the second execution unit that causes the first generative AI to execute the remaining sentence generation processes by using the generated prompt.

### CROSS-REFERENCE TO RELATED APPLICATIONS

The present application claims priority to and incorporates by reference the entire contents of Japanese Patent Application No. 2024-099303 filed in Japan on Jun. 20, 2024.

### BACKGROUND OF THE INVENTION

### 1. Field of the Invention

The present invention relates to an information processing apparatus, an information processing method, and an information processing program.

### 2. Description of the Related Art

In recent years, generative AI that generates new content using a model obtained by learning various data has been developed and spread from each company.

However, the generative AI of each company has a difference in performance, and for example, there are a wide variety of performances such as a high-cost model in which there are many variations of sentences in response to an input prompt and a low-cost model in which there are few variations of sentences in response to an input prompt. For this reason, conventionally, in a case where it is attempted to output a large amount of highly accurate sentences using a model having many variations of sentences, the cost increases.

### SUMMARY OF THE INVENTION

The information processing apparatus according to the present application includes the first execution unit that executes a predetermined number of sentence generation processes, among a plurality of sentence generation processes continuously executed by using a first generative AI, by using a second generative AI having sentence generation accuracy higher than that of the first generative AI, the generation unit that generates a prompt including an execution result of the second generative AI by the first execution unit, the prompt being for causing the first generative AI to execute remaining sentence generation processes other than the predetermined number of sentence generation processes executed by using the second generative AI, and the second execution unit that causes the first generative AI to execute the remaining sentence generation processes by using the generated prompt.

### BRIEF DESCRIPTION OF THE DRAWINGS

FIG. 1 is a diagram illustrating processing executed by an information processing apparatus according to an embodiment;

FIG. 2 is a diagram illustrating a configuration example of an information processing system according to an embodiment;

FIG. 3 is a diagram illustrating a configuration example of the information processing apparatus according to an embodiment;

FIG. 4 is a diagram illustrating an example of model information;

FIG. 5 is a flowchart illustrating a processing procedure of processing executed by the information processing apparatus according to the embodiment; and

FIG. 6 is a diagram illustrating an example of a hardware configuration.

### DETAILED DESCRIPTION OF THE PREFERRED EMBODIMENTS

Hereinafter, modes (hereinafter, referred to as an “embodiment”) for implementing an information processing apparatus, an information processing method, and an information processing program according to the present application will be described in detail with reference to the drawings. Note that the information processing apparatus, the information processing method, and the information processing program according to the present application are not limited by the embodiment. In the following embodiments, the same parts are denoted by the same reference numerals, and redundant description will be omitted.

### EMBODIMENT

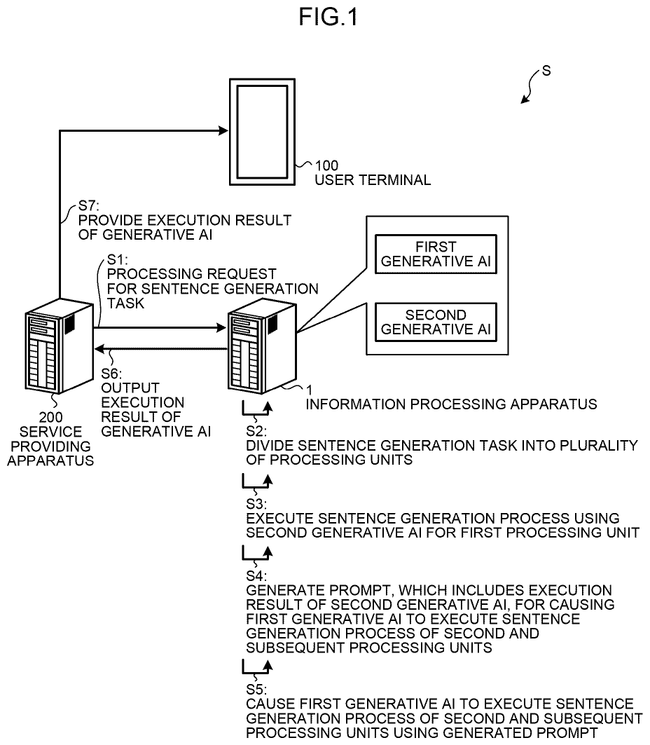

First, processing executed by the information processing apparatus according to the embodiment will be described with reference to FIG. 1. FIG. 1 is a diagram illustrating processing executed by the information processing apparatus according to the embodiment. Note that FIG. 1 illustrates an operation example of an information processing system S including the information processing apparatus 1 according to the embodiment.

As illustrated in FIG. 1, an information processing system S according to the embodiment includes the information processing apparatus 1, a user terminal 100, and a service providing apparatus 200. Note that, although FIG. 1 illustrates an example in which the information processing apparatus 1 and the service providing apparatus 200 are configured separately, the information processing apparatus 1 and the service providing apparatus 200 may be configured as an integrated server apparatus.

As illustrated in FIG. 1, the information processing system S according to the embodiment executes a predetermined number of sentence generation processes, among a plurality of sentence generation processes continuously executed by using a first generative AI, by using a second generative AI having sentence generation accuracy higher than that of the first generative AI, generates a prompt including an execution result of the second generative AI, the prompt being for causing the first generative AI to execute remaining sentence generation processes other than the predetermined number of sentence generation processes executed by using the second generative AI, and causes the first generative AI to execute the remaining sentence generation processes by using the generated prompt.

Note that, hereinafter, a low-accuracy and low-cost model is referred to as the first generative AI, and a high-accuracy and high-cost model is referred to as the second generative AI. Note that the accuracy mentioned here is, for example, the number of variations (number of characters, types of words to be used, and the like) of the sentence output from the generative AI in a case where the same prompt is input, and the presence or absence of a disadvantage with respect to the task field (field of literature to be generated, multilingual, specialty, computer language) of the sentence to be generated.

That is, in a case where the same prompt is input, the number of characters and the types of words to be used are small in the low-precision first generative AI as compared with the high-precision second generative AI, and there is a disadvantage in the field of the task. In other words, the second generative AI is a model having a larger number of characters and a larger number of types of words to be used than the first generative AI and having no disadvantage in the field of tasks.

Note that, even in the low-precision first generative AI, it is possible to guide the user to output the sentence with accuracy arranged in the second generative AI by setting the prompt condition in detail.

Furthermore, the cost here is a financial or temporal cost for training and operation of the generative AI. For example, the cost for training of the generative AI is a cost obtained by combining the amount of data for training the generative AI, the training period, and computer performance necessary for training in a case where the generative AI is developed by the company, and the first generative AI with low accuracy has a smaller amount of data for training, a shorter training period, and lower computer performance necessary for training than the second generative AI with high accuracy, so that the cost is reduced. Furthermore, for example, regarding the cost required for the operation of the generative AI, in a case where the generative AI is used as the subscription, the first generative AI means that the monthly usage fee is inexpensive (low cost) as compared with the second generative AI. In addition, the cost may include a power charge at the time of operation. For example, since the second generative AI has higher accuracy (the amount of data for training is large, and the amount of processing for the prompt is large) than the first generative AI, the power consumption is large, and the power charge is accordingly increased (high cost).

In the present disclosure, in a case where a large amount of sentence generation processes are performed by the generative AI, a part thereof is executed by the high-accuracy and high-cost second generative AI, and a prompt including a high-accuracy execution result of the second generative AI as a model solution is input to the first generative AI. As a result, as compared with a case where a large amount of sentence generation processes are all performed by the second generative AI, a part of the processing can be performed by the first generative AI, so that the cost can be reduced. In addition, as compared with a case where a large amount of sentence generation processes are all performed by the first generative AI, since the model answer is generated by the second generative AI, it is possible to generate a sentence with high accuracy even by the first generative AI. That is, according to the information processing apparatus 1 according to the embodiment, it is possible to output a large amount of highly accurate sentences while suppressing cost.

Specifically, first, the information processing apparatus 1 receives a processing request for a sentence generation task from the service providing apparatus 200 (step S1). The sentence generation task includes a one-sentence generation task and a multi-sentence generation task.

The one-sentence generation task is, for example, a task of translating or summarizing one book (specialized literatures such as novels, laws, and medical documents). The multi-sentence generation task is, for example, a task in which the generative AI creates answers to a large number of questions on a Q&A site. That is, a task having no division (consecutive sentences) is the one-sentence generation task, and a task having divisions (division for each question) is the multi-sentence generation task.

Whether the sentence generation task is a one-sentence generation task or a multi-sentence generation task may be designated by, for example, a requester (a user who has requested the service providing apparatus 200 for a processing request, or the like), or the information processing apparatus 1 may be configured to analyze the content of the sentence generation task and automatically determine the sentence generation task.

Subsequently, the information processing apparatus 1 divides the received sentence generation task into a plurality of processing units (step S2). Note that each processing unit corresponds to each document generation process to be described later. For example, in the case of one-sentence generation task, the information processing apparatus 1 divides the sentence generation task into a plurality of processing units according to a predetermined division condition. Specifically, the information processing apparatus 1 detects developmental divisions such as chapters, headings, or the like in a book, and divides the book such that each division becomes each processing unit. Note that, in a case where there is no developmental division (undetectable), for example, division may be performed for each predetermined number of characters (or the number of rows).

Furthermore, in the case of the multi-sentence generation task, the information processing apparatus 1 performs division assuming each sentence generation task as a processing unit. For example, in the case of a Q&A site, the information processing apparatus 1 performs division so that each question is a processing unit.

As described above, the information processing apparatus 1 can clearly distinguish the processing unit for the first generative AI and the processing unit for the second generative AI in the subsequent stage by dividing the sentence generation task.

Subsequently, the information processing apparatus 1 executes the sentence generation process using the second generative AI for the first processing unit (step S3). Specifically, the information processing apparatus 1 generates a prompt for causing the second generative AI to execute the sentence generation process (hereinafter, the second generative AI prompt) for the processing unit that executes the sentence generation process first among the plurality of processing units. For example, in a case where the sentence generation process is the summary (or) translation, the information processing apparatus 1 generates a second generative AI prompt including a set of a text of the first processing unit and a statement instructing the summary (or translation). For example, the information processing apparatus 1 generates a second generative AI prompt “Please summarize the following sentence. - - - (corresponding to the sentence)”.

Furthermore, in a case where the sentence generation process is answer creation for a question, the information processing apparatus 1 generates a second generative AI prompt for setting a text of a question as the first processing unit and a statement instructing answer creation. For example, the information processing apparatus 1 generates a second generative AI prompt “Please create an answer to the following question. - - - (corresponding to the question)”.

Then, the information processing apparatus 1 inputs the generated prompt to the second generative AI, and acquires the sentence (abstract sentence or answer sentence) generated by the sentence generation process executed by the second generative AI as an execution result. That is, in step S3, a model solution that is an execution result of the second generative AI is generated.

Note that, in FIG. 1, the second generative AI prompt is generated only for the first processing unit, but for example, a plurality of processing units may be grouped by similarity, and the second generative AI prompt may be generated for each group. For example, in a case where the processing unit is a question, the information processing apparatus 1 groups questions having similar question contents. The information processing apparatus 1 vectorizes each question using, for example, Word2Vec or the like, and determines similarity by cosine similarity or the like.

Then, for each group, the information processing apparatus 1 generates a second generative AI prompt for an arbitrary one (or two or more) processing unit among a plurality of processing units (questions) included in each group.

As described above, the information processing apparatus 1 groups the plurality of processing units for each similar processing unit and generates the model solution by the second generative AI for each group, so that the model solution can be generated for each tendency of the content of the processing unit. Therefore, it is possible to prevent the accuracy of the execution result of the generative AI from varying for each content of the processing unit in the entire sentence generation task.

Subsequently, the information processing apparatus 1 generates a prompt, which includes the execution result of the second generative AI, for causing the first generative AI to execute the sentence generation process of the second and subsequent processing units (step S4).

Specifically, the information processing apparatus 1 generates a prompt including the second generative AI prompt generated in step S3, an execution result of the second generative AI (model solution), and a statement instructing execution of the sentence generation process for the second and subsequent processing units (hereinafter, the first generative AI prompt).

For example, the information processing apparatus 1 generates a first generative AI prompt such as “AA (corresponding to model solution) is a model solution. Please summarize the following sentence with reference to this model solution. BB (corresponding to the second processing unit)”. Note that, in order to generate the first generative AI prompt corresponding to the third processing unit, the above “BB” is replaced with the text of the third processing unit.

Subsequently, the information processing apparatus 1 causes the first generative AI to execute the sentence generation process of the second and subsequent processing units using the generated prompt (step S5). Specifically, the information processing apparatus 1 inputs the generated first generative AI prompt and the second and subsequent processing units to the first generative AI, thereby acquiring the execution result of the sentence generation process for the second and subsequent processing units from the first generative AI.

Subsequently, the information processing apparatus 1 outputs an execution result of the generative AI (the first generative AI and the second generative AI) to the service providing apparatus 200 (step S6), and the service providing apparatus 200 provides the received execution result of the generative AI to the user terminal 100 (step S7).

Specifically, the information processing apparatus 1 outputs the execution result of the second generative AI in step S3 and the execution result of the first generative AI in step S5 to the service providing apparatus 200. Note that the information processing apparatus 1 may directly provide the execution result of the generative AI to the user terminal 100.

As described above, the information processing apparatus 1 according to the embodiment causes the second generative AI having high generation accuracy of sentence to execute some sentence generation process among a large number of sentence generation tasks. Then, the information processing apparatus 1 inputs a prompt including the execution result of the sentence generation process of the second generative AI to the first generative AI, thereby causing the first generative AI to execute the remaining sentence generation processes. As a result, since the first generative AI executes the sentence generation process with reference to the execution result of the second generative AI, it is possible to execute a large amount of sentence generation processes at low cost by the first generative AI while securing the generation accuracy of the sentence of the second generative AI. That is, according to the information processing apparatus 1 according to the embodiment, it is possible to output a large amount of highly accurate sentences while suppressing cost.

Note that although the case where the sentence generation task is a sentence (text) has been described above as an example, the sentence generation task may be a voice or an image.

For example, in the case of a voice, the information processing apparatus 1 generates a first generative AI prompt and a second generative AI prompt in the same manner as described above by using a large amount of voice data (the data may be divided or may be one piece of data such as a sound for a long-time) as a sentence generation task, and generates a sentence based on the voice by using the first generative AI and the second generative AI. The sentence based on the voice includes, for example, a sentence in which the voice is directly converted into a text such as transcription, a sentence in which the content of the voice is summarized (or translated), and the like.

For example, in the case of an image, the information processing apparatus 1 generates a first generative AI prompt and a second generative AI prompt in the same manner as described above by using a large amount of image data (the data may be divided or may be one piece of data such as a moving image for a long-time) as a sentence generation task, and generates a sentence based on the image by using the first generative AI and the second generative AI. Examples of the sentence based on the image include a sentence describing the content of the image, and a sentence in which an object appearing in the image is converted into text.

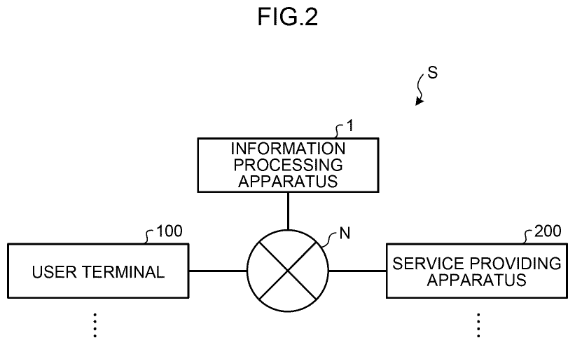

Next, a configuration example of the information processing system S according to the embodiment will be described with reference to FIG. 2. FIG. 2 is a block diagram illustrating a configuration example of the information processing system S according to the embodiment. As illustrated in FIG. 2, in the information processing system S according to the embodiment, an information processing apparatus 1, a plurality of user terminals 100, and a plurality of service providing apparatuses 200 are connected to a network N in a wired or wireless manner. The network N is, for example, a network such as the Internet, a wide area network (WAN), or a local area network (LAN).

The information processing apparatus 1 is a server apparatus that executes the information processing method according to the embodiment. The information processing apparatus 1 executes a predetermined number of sentence generation processes, among a plurality of sentence generation processes continuously executed by using a first generative AI, by using a second generative AI having sentence generation accuracy higher than that of the first generative AI, generates a prompt including an execution result of the second generative AI, the prompt being for causing the first generative AI to execute remaining sentence generation processes other than the predetermined number of sentence generation processes executed by using the second generative AI, and causes the first generative AI to execute the remaining sentence generation processes by using the generated prompt.

Furthermore, the information processing apparatus 1 is an information processing apparatus that cooperates with the plurality of user terminals 100 and the plurality of service providing apparatuses 200 to provide an application programming interface (API) service or the like for various applications (hereinafter, an app) or the like and various data to the plurality of user terminals 100 and the plurality of service providing apparatuses 200, and is implemented by a server apparatus, a cloud system, or the like.

Furthermore, the information processing apparatus 1 may be an information processing apparatus that provides some kind of Web service online to the plurality of user terminals 100 and the plurality of service providing apparatuses 200. For example, the information processing apparatus 1 may provide, as Web services, services such as Internet connection, a search service, a social networking service (SNS), electronic commerce (EC), electronic payment, an online game, online banking, online trading, lodging/ticket reservation, moving image/music distribution, news, a map, a route search, route guidance, route information, operation information, and weather forecast. In practice, the information processing apparatus 1 may mediate the Web service in cooperation with various servers that provide the Web service as described above, or may be in charge of processing the Web service.

The user terminal 100 is a terminal device possessed by a user who uses a service provided by the service providing apparatus 200. As the user terminal 100, any type of terminal device such as a smartphone, a desktop PC, a notebook PC, or a tablet PC can be used. The user terminal 100 transmits various types of information to the information processing apparatus 1 and the like, and receives information provided from the information processing apparatus 1 and the like.

The service providing apparatus 200 is a server apparatus that provides various services to a user who possesses the user terminal 100. The service providing apparatus 200 transmits various types of information to the information processing apparatus 1, the user terminal 100, and the like, and receives information provided from the information processing apparatus 1, the user terminal 100, and the like.

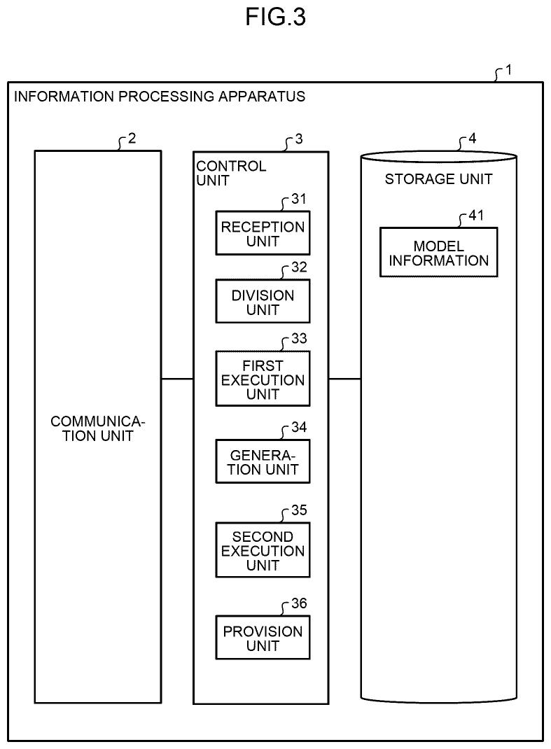

Next, a configuration example of the information processing apparatus 1 will be described with reference to FIG. 3.

FIG. 3 is a diagram illustrating a configuration example of the information processing apparatus 1 according to the embodiment. As illustrated in FIG. 3, the information processing apparatus 1 includes a communication unit 2, a control unit 3, and a storage unit 4. The control unit 3 includes a reception unit 31, a division unit 32, a first execution unit 33, a generation unit 34, a second execution unit 35, and a provision unit 36. The storage unit 4 stores model information 41.

The communication unit 2 is implemented by, for example, a network interface card (NIC) or the like. The communication unit 2 is connected to a network in a wired or wireless manner.

The control unit 3 is a controller, and is implemented by, for example, a processor such as a central processing unit (CPU) or a micro processing unit (MPU) executing various programs (corresponding to an example of an information processing program) stored in a storage device inside the information processing apparatus 1 using a RAM or the like as a work area. Furthermore, the control unit 3 is a controller, and may be implemented by, for example, an integrated circuit such as an application specific integrated circuit (ASIC), a field programmable gate array (FPGA), or a general purpose graphic processing unit (GPGPU).

The storage unit 4 is implemented by, for example, a semiconductor memory element such as a random access memory (RAM) or a flash memory, or a storage device such as a hard disk or an optical disk.

The model information 41 is information regarding the model of the generative AI.

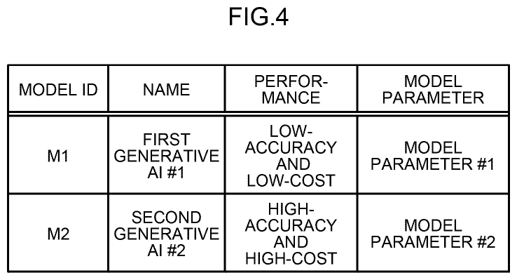

FIG. 4 is a diagram illustrating an example of the model information 41. As illustrated in FIG. 4, the model information 41 includes items such as “model ID”, “name”, “performance”, and “model parameter”.

The “model ID” is identification information for identifying models. The “name” is information indicating the name of the model of the generative AI. The “performance” is information indicating the performance of the model. The “model parameter” is information regarding a parameter of the model, and includes, for example, information such as a weighting coefficient in a neural network or deep learning.

Next, each function (the reception unit 31, the division unit 32, the first execution unit 33, the generation unit 34, the second execution unit 35, and the provision unit 36) of the control unit 3 of the information processing apparatus 1 will be described.

The reception unit 31 receives a processing request for a sentence generation task from the service providing apparatus 200. The sentence generation task includes a one-sentence generation task and a multi-sentence generation task.

The division unit 32 divides the received sentence generation task into a plurality of processing units. Note that each processing unit corresponds to each document generation process to be described later. For example, in the case of one-sentence generation task, the division unit 32 divides the sentence generation task into a plurality of processing units according to a predetermined division condition. Specifically, the division unit 32 detects developmental divisions such as chapters, headings, or the like in a book, and divides the book such that each division becomes each processing unit. Note that, in a case where there is no developmental division (undetectable), for example, division may be performed for each predetermined number of characters (or the number of rows).

Furthermore, in the case of the multi-sentence generation task, the division unit 32 performs division assuming each sentence generation task as a processing unit. For example, in the case of a Q&A site, the division unit 32 performs division so that each question is a processing unit.

The first execution unit 33 executes the sentence generation process using the second generative AI for the first processing unit. Specifically, the first execution unit 33 generates the second generative AI prompt for causing the second generative AI to execute the sentence generation process for the processing unit that executes the sentence generation process first among the plurality of processing units. For example, in a case where the sentence generation process is the summary (or) translation, the first execution unit 33 generates a second generative AI prompt including a set of a text of the first processing unit and a statement instructing the summary (or translation). For example, the first execution unit 33 generates a second generative AI prompt “Please summarize the following sentence. - - - (corresponding to the sentence)”.

Furthermore, in a case where the sentence generation process is answer creation for a question, the first execution unit 33 generates a second generative AI prompt for setting a text of a question as the first processing unit and a statement instructing answer creation. For example, the first execution unit 33 generates a second generative AI prompt “Please create an answer to the following question. - - - (corresponding to the question)”.

Then, the first execution unit 33 inputs the generated prompt to the second generative AI, and acquires the sentence (abstract sentence or answer sentence) generated by the sentence generation process executed by the second generative AI as an execution result.

Note that the first execution unit 33 generates the second generative AI prompt only for the first processing unit, but the first execution unit 33 may group, for example, plurality of processing units by similarity, and generate the second generative AI prompt for each group. For example, in a case where the processing unit is a question, the first execution unit 33 groups questions having similar question contents. The first execution unit 33 vectorizes each question using, for example, Word2Vec or the like, and determines similarity by cosine similarity or the like.

Then, for each group, the first execution unit 33 generates a second generative AI prompt for an arbitrary one (or two or more) processing unit among a plurality of processing units (questions) included in each group.

The generation unit 34 generates a prompt, which includes the execution result of the second generative AI, for causing the first generative AI to execute the sentence generation process of the second and subsequent processing units.

Specifically, the generation unit 34 generates the first generative AI prompt including the second generative AI prompt generated by the first execution unit 33, an execution result of the second generative AI (model solution), and a statement instructing execution of the sentence generation process for the second and subsequent processing units.

For example, the generation unit 34 generates a first generative AI prompt such as “AA (corresponding to model solution) is a model solution. Please summarize the following sentence with reference to this model solution. BB (corresponding to the second processing unit)”. Note that, in order to generate the first generative AI prompt corresponding to the third processing unit, the above “BB” is replaced with the text of the third processing unit.

The second execution unit 35 causes the first generative AI to execute the sentence generation process of the second and subsequent processing units using the generated prompt. Specifically, the second execution unit 35 inputs the generated first generative AI prompt and the second and subsequent processing units to the first generative AI, thereby acquiring the execution result of the sentence generation process for the second and subsequent processing units from the first generative AI.

The provision unit 36 provides an execution result of the generative AI (the first generative AI and the second generative AI) to the service providing apparatus 200. Specifically, the provision unit 36 outputs the execution result of the second generative AI and the execution result of the first generative AI to the service providing apparatus 200. Note that the provision unit 36 may directly provide the execution result of the generative AI to the user terminal 100.

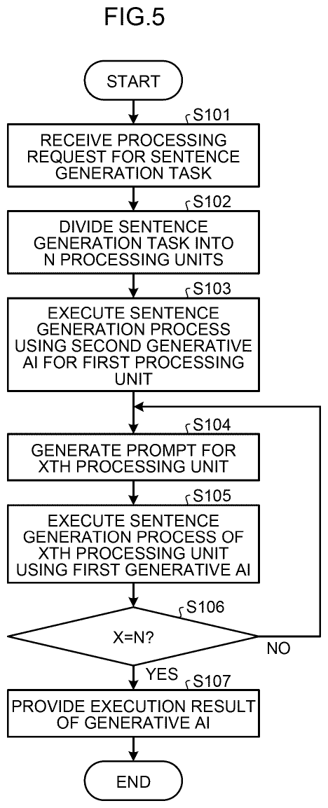

Next, with reference to FIG. 5, a processing procedure of processing executed by the information processing apparatus 1 according to the embodiment will be explained. FIG. 5 is a flowchart illustrating a processing procedure of processing executed by the information processing apparatus 1 according to the embodiment.

As illustrated in FIG. 5, the control unit 3 first receives a processing request for a sentence generation task from the service providing apparatus 200 (step S101).

Subsequently, the control unit 3 divides the received sentence generation task into N processing units (step S102).

Subsequently, the control unit 3 executes the sentence generation process using the second generative AI for the first processing unit (step S103).

Subsequently, the control unit 3 generates a prompt for the X (X≥2)th processing unit among the N processing units (step S104).

Subsequently, the control unit 3 executes the document generation process of the Xth processing unit using the first generative AI (step S105).

Subsequently, the control unit 3 determines whether or not X is N, that is, whether or not the sentence generation process of the last Nth processing unit among the N processing units has been completed (step S106).

In a case where X is N, that is, in a case where the sentence generation process of the last Nth processing unit among the N processing units is completed (step S106: Yes), the control unit 3 provides the execution result of the generative AI to the service providing apparatus 200 (step S107), and ends the process.

Note that, in a case where X is not N, that is, in a case where the sentence generation process of the last Nth processing unit among the N processing units has not been completed (step S106: No), the control unit 3 counts up X and returns to step S104.

### Others

In addition, among the processing described in the above embodiment, a part of the processing described as being automatically performed can be manually performed. Alternatively, all or part of the processing described as being performed manually can be automatically performed by a known method. In addition, the processing procedures, specific names, and information including various data and parameters illustrated in the document and the drawings can be arbitrarily changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like.

For example, a part or all of the storage unit 4 illustrated in FIG. 3 may be held in a storage server or the like instead of being held by each device. In this case, each device acquires various types of information by accessing the storage server.

### Hardware Configuration

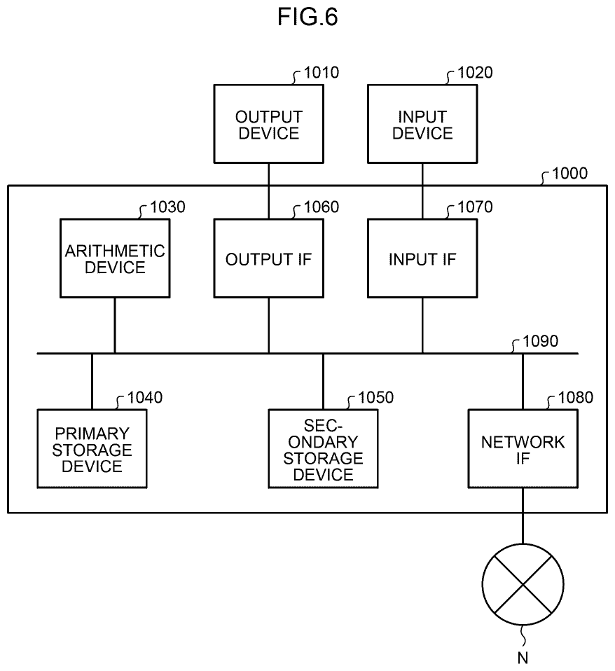

Furthermore, the information processing apparatus 1 according to the above-described embodiment is implemented by a computer 1000 having a configuration as illustrated in FIG. 6, for example. FIG. 6 is a diagram illustrating an example of a hardware configuration. The computer 1000 is connected to an output device 1010 and an input device 1020, and has a form in which an arithmetic device 1030, a primary storage device 1040, a secondary storage device 1050, an output interface (IF) 1060, an input IF 1070, and a network IF 1080 are connected by a bus 1090.

The arithmetic device 1030 operates on the basis of a program stored in the primary storage device 1040 or the secondary storage device 1050, a program read from the input device 1020, or the like, and executes various types of processing. The primary storage device 1040 is a memory device such as a RAM that temporarily stores data used for various calculations by the arithmetic device 1030. In addition, the secondary storage device 1050 is a storage device in which data used for various arithmetic operations by the arithmetic device 1030 and various databases are registered, and is implemented by a read only memory (ROM), a hard disk drive (HDD), a flash memory, and the like.

The output IF 1060 is an interface for transmitting information to be output to the output device 1010 that outputs various types of information such as a monitor and a printer, and is implemented by, for example, a connector of a standard such as a universal serial bus (USB), a digital visual interface (DVI), or a high definition multimedia interface (HDMI) (registered trademark). Furthermore, the input IF 1070 is an interface for receiving information from various input devices 1020 such as a mouse, a keyboard, and a scanner, and is implemented by, for example, a USB or the like.

Note that the input device 1020 may be, for example, a device that reads information from an optical recording medium such as a compact disc (CD), a digital versatile disc (DVD), or a phase change rewritable disk (PD), a magneto-optical recording medium such as a magneto-optical disk (MO), a tape medium, a magnetic recording medium, a semiconductor memory, or the like. Furthermore, the input device 1020 may be an external storage medium such as a USB memory.

The network IF 1080 receives data from another device via the network N and transmits the data to the arithmetic device 1030, and transmits data generated by the arithmetic device 1030 to another device via the network N.

The arithmetic device 1030 controls the output device 1010 and the input device 1020 via the output IF 1060 and the input IF 1070. For example, the arithmetic device 1030 loads a program from the input device 1020 or the secondary storage device 1050 onto the primary storage device 1040, and executes the loaded program.

For example, in a case where the computer 1000 functions as the information processing apparatus 1, the arithmetic device 1030 of the computer 1000 realizes the function of the control unit 3 by executing the program loaded on the primary storage device 1040.

### Effects

As described above, the information processing apparatus 1 according to the embodiment includes the first execution unit 33 that executes a predetermined number of sentence generation processes, among a plurality of sentence generation processes continuously executed by using a first generative AI, by using a second generative AI having sentence generation accuracy higher than that of the first generative AI, the generation unit 34 that generates a prompt including an execution result of the second generative AI by the first execution unit 33, the prompt being for causing the first generative AI to execute remaining sentence generation processes other than the predetermined number of sentence generation processes executed by using the second generative AI, and the second execution unit 35 that causes the first generative AI to execute the remaining sentence generation processes by using the generated prompt.

According to such a configuration, it is possible to output a large amount of highly accurate sentences while suppressing cost.

Although some of the embodiments of the present application have been described in detail with reference to the drawings, these are merely examples, and the present invention can be implemented in other forms subjected to various modifications and improvements based on the knowledge of those skilled in the art, including the aspects described in the disclosure of the invention.

### Others

In addition, among the processing described in the above embodiments, all or a part of the processing described as being automatically performed can be manually performed, or all or a part of the processing described as being manually performed can be automatically performed by a known method. In addition, the processing procedures, specific names, and information including various data and parameters illustrated in the document and the drawings can be arbitrarily changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like.

In addition, each processing described in the above-described embodiments can be appropriately combined within a range in which the processing contents do not contradict each other.

In addition, the “part (section, module, unit)” described above can be read as “means”, “circuit”, or the like. For example, the control unit 3 can be replaced with a control means or a control circuit.

According to one aspect of the embodiment, it is possible to output a large amount of highly accurate sentences while suppressing cost.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a first execution unit that executes a predetermined number of sentence generation processes, among a plurality of sentence generation processes continuously executed by using a first generative AI, by using a second generative AI having sentence generation accuracy higher than that of the first generative AI;
a generation unit that generates a prompt including an execution result of the second generative AI by the first execution unit, the prompt being for causing the first generative AI to execute remaining sentence generation processes other than the predetermined number of sentence generation processes executed by using the second generative AI; and
a second execution unit that causes the first generative AI to execute the remaining sentence generation processes by using the generated prompt.

2. The information processing apparatus according to claim 1 further comprising
a division unit configured to divide the sentence generation task that has received processing request into a plurality of processing units, wherein
the plurality of sentence generation processes is
processing corresponding to each of the plurality of processing units.

3. The information processing apparatus according to claim 2, wherein
the sentence generation task is one task, and
the division unit is configured to
divide the one sentence generation task into the plurality of processing units.

4. The information processing apparatus according to claim 2, wherein
the sentence generation task is a plurality of tasks, and
the division unit is configured to
divide the plurality of sentence generation tasks into the plurality of processing units.

5. The information processing apparatus according to claim 2,
the division unit is configured to
group the plurality of processing units for each similar processing unit; and
the first execution unit is configured to
execute the sentence generation process using the second generative AI for at least one or more processing units among the processing units included in a group.

6. An information processing method executed by a computer,
the method comprising:
a first execution step of executing a predetermined number of sentence generation processes, among a plurality of sentence generation processes continuously executed by using a first generative AI, by using a second generative AI having sentence generation accuracy higher than that of the first generative AI;
a generation step of generating a prompt including an execution result of the second generative AI by the first execution step, the prompt being for causing the first generative AI to execute remaining sentence generation processes other than the predetermined number of sentence generation processes executed by using the second generative AI; and
a second execution step of causing the first generative AI to execute the remaining sentence generation processes by using the generated prompt.

7. A non-transitory computer-readable storage medium having stored therein an information processing program causing a computer to execute a process comprising:
a first execution procedure of executing a predetermined number of sentence generation processes, among a plurality of sentence generation processes continuously executed by using a first generative AI, by using a second generative AI having sentence generation accuracy higher than that of the first generative AI;
a generation procedure of generating a prompt including an execution result of the second generative AI by the first execution procedure, the prompt being for causing the first generative AI to execute remaining sentence generation processes other than the predetermined number of sentence generation processes executed by using the second generative AI; and
a second execution procedure of causing the first generative AI to execute the remaining sentence generation processes by using the generated prompt.
